(19) United States
(12) Patent Application Publication
(10) Pub. No.: US 2024/0127263 A1
(43) Pub. Date: Apr. 18, 2024

(54) Guidance Rule-Based Compliance Management

(71) Applicant: AT&T Intellectual Property I, L.P., Atlanta, GA (US)

(72) Inventors: Barrett Kreiner, Woodstock, GA (US); Aaron Cox, Issaquah, WA (US); Michael Spurlock, San Antonio, TX (US)

(73) Assignee: AT&T Intellectual Property I, L.P., Atlanta, GA (US)

(21) Appl. No.: 17/968,017

(22) Filed: Oct. 18, 2022

(51) Int. Cl. G06Q 30/00; G06Q 30/06

(52) U.S. Cl. CPC G06Q 30/018; G06Q 30/0603

(57) ABSTRACT

The concepts and technologies disclosed herein are directed to guidance rule-based compliance management. According to one aspect disclosed herein, an integrated technology catalog system (“system”) can provide an interface through which a technology catalog can be accessed to view a technology product and evaluate the technology product in a given context. The system can receive, via the interface, a request to evaluate the technology product in the given context. In response to the request, the system can identify whether at least one guidance rule is applicable to the technology product in the given context. In response to identifying that the at least one guidance rule is applicable to the technology product in the given context, the system can generate a report for the technology product. The report can include all applicable guidance rules for the technology product. The system can output the report.

### BACKGROUND

Companies may have multiple business teams, such as legal, supply chain, security, asset management, standards, executive, and the like, each with its own policies and processes governed by corresponding compliance groups. Often times, business teams have to engage each compliance group in their own process to identify whether or not usage of a technology product needs to be managed for compliance. Often times, business teams are responsible for having awareness of the compliance policies and processes of other business teams. Even if a business team is fully aware of the compliance policies and processes of other business teams, the business team may misinterpret the compliance policies and/or processes. In other instances, the business team may ignore the compliance policies and/or processes in order to meet deadlines (e.g., due to pressure from upper management) or for other reasons (e.g., adherence to a particularly difficult compliance policy). Without proper oversight, business teams may be non-compliant for years and plead ignorance when confronted about their non-compliance. This practice may lend itself to a culture of forgiveness that may be abused.

### SUMMARY

The concepts and technologies disclosed herein are directed to guidance rule-based compliance management. According to one aspect disclosed herein, an integrated technology catalog (“ITC”) system can provide an interface through which an ITC can be accessed to view a technology product and evaluate the technology product in a given context. In some embodiments, the interface can include a search function that enables users to search the ITC. The ITC system can receive, via the interface, a request to evaluate the technology product in the given context. The request can specify a bill of materials. In response to the request, the system can identify whether at least one guidance rule is applicable to the technology product in the given context. In response to identifying that the at least one guidance rule is applicable to the technology product in the given context, the integrated technology catalog system can generate a report for the technology product. The report can include all applicable guidance rules for the technology product. The system can output the report.

In some embodiments, the technology catalog can include a plurality of technology products, including the technology product. The technology catalog can include a set of core attributes that uniquely identify the technology product. The technology catalog also can include a set of additional attributes of the technology product.

In some embodiments, the guidance rule can include information to be provided to a user. In some embodiments, the guidance rule includes information that can be used to trigger an activity. The information can represent a best practice, a policy, or a strategy. In some embodiments, the guidance rule includes a logic snippet. In these embodiments, the integrated technology catalog system can identify, via execution of the logic snippet, whether the guidance rule is applicable to the technology product in the given context. The guidance rule(s) can be defined and managed by a stakeholder group (e.g., an authoritative stakeholder group).

In some embodiments, the context can include an ongoing use of the technology product. In other embodiments, the context can include new use of the technology product. In other embodiments, the context can include a date. In other embodiments, the context can include a functionality of a business application and/or other attributes.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

Other systems, methods, and/or computer program products according to embodiments will be or become apparent to one with skill in the art upon review of the following drawings and detailed description. It is intended that all such additional systems, methods, and/or computer program products be included within this description, be within the scope of this disclosure.

### BRIEF DESCRIPTION OF THE DRAWINGS

FIG. 1 is a block diagram illustrating aspects of an illustrative operating environment in which the concepts and technologies disclosed herein can be implemented.

FIGS. 2A-2B are interface diagrams illustrating aspects of example guidance rules, according to an illustrative embodiment of the concepts and technologies disclosed herein.

FIG. 3 is an interface diagram illustrating aspects of example overlay data, according to an illustrative embodiment of the concepts and technologies disclosed herein.

FIGS. 4A-4J are interface diagrams illustrating aspects of an example integrated technology catalog (“ITC”), according to an illustrative embodiment of the concepts and technologies disclosed herein.

FIG. 5 is a flow diagram illustrating aspects of a method for providing guidance rule-based compliance management, according to an illustrative embodiment.

FIG. 6 is a block diagram illustrating an example computer system that can be used to implement aspects of the concepts and technologies disclosed herein, according to an illustrative embodiment.

FIG. 7 is a block diagram illustrating a network that can be used to implement aspects of the concepts and technologies disclosed herein, according to an illustrative embodiment.

FIG. 8 is a block diagram illustrating an example cloud computing platform that can be used to implement aspects of the concepts and technologies disclosed herein, according to an illustrative embodiment.

FIG. 9 is a block diagram illustrating an example mobile device and components thereof, according to an illustrative embodiment.

### DETAILED DESCRIPTION

The concepts and technologies disclosed herein are directed to guidance rule-based compliance management. A business may have multiple business applications. A business application is a collection of one or more technologies, managed by a business team, to provide one or more functionalities and/or one or more services. Multiple stakeholder compliance groups, each with a set of policies and processes. For example, the business may have compliance groups for legal, supply chain, security, asset management, standards, executive directives, and/or the like. Often times, business teams are required to engage with each compliance group using their own process just to identify if a manageable issue exists. These business teams are responsible for awareness of the various compliance groups and interpreting whether or not they should engage with a given compliance group. A business team may make a faulty interpretation. Business teams typically are not aware of all processes. Moreover, additional engagement time with compliance group slows down business team project delivery times, or may halt the delivery entirely due to a compliance issue. A business team may identify that it is more effective to bypass the compliance group's processes. As business team members change over time, knowledge of the initial non-compliance is lost. Without proper oversight, business teams may be non-compliant for years and, when non-compliance is identified, the business team can plead ignorance to the non-compliance and even to the compliance groups' process itself. This practice may lend itself to a culture of forgiveness that may be abused.

In an effort to address compliance-related issues, businesses may need to consult multiple systems. A business may consult multiple catalog systems, such as catalogs of business standards and non-standards technologies. A business also may consult a metadata database that identifies technologies, the usage of which should be tracked, which can then be cross-referenced to the catalog systems. Additional systems can include software bill of materials data (e.g., technology dependencies), vulnerability data, and other data associated with the technologies utilized by the business. Each system can have different representations of common data, such as technology vendor, product name, and product version. As such, businesses should align the information in systems to handle various requests and reports. Currently, this task requires numerous hours and continued oversight to ensure the systems are aligned properly. The concepts and technologies disclosed herein utilize a common catalog system that is easier to maintain and requires less time manage.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific embodiments or examples. Referring now to the drawings, in which like numerals represent like elements throughout the several figures, aspects of systems, devices, computer-readable storage mediums, and methods for guidance rule-based compliance management will be described.

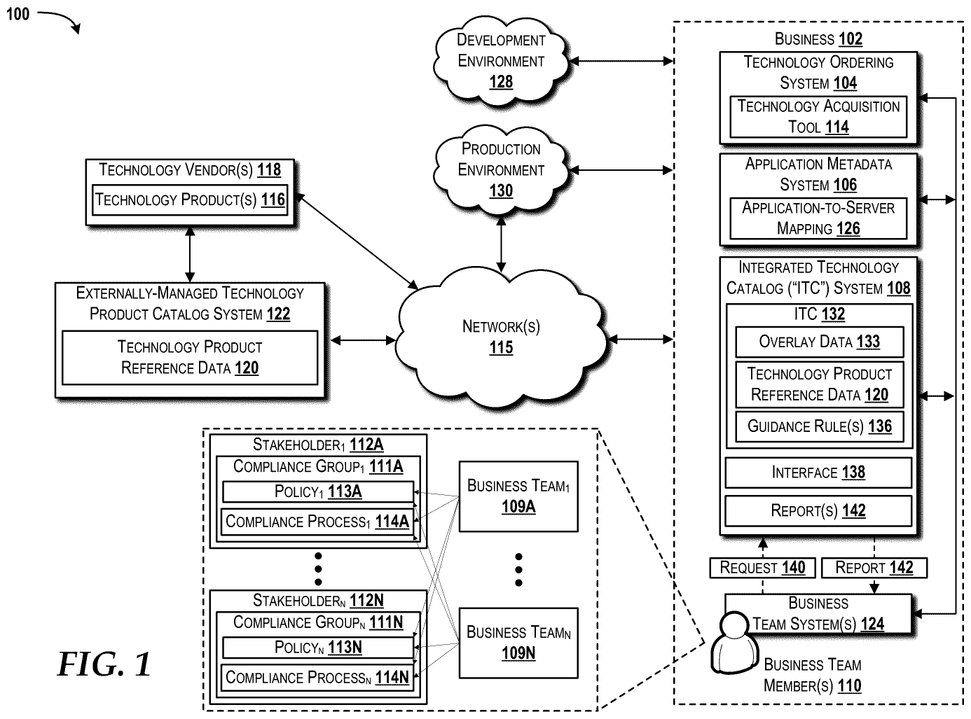

Turning now to FIG. 1, a block diagram illustrating an operating environment 100 in which the concepts and technologies disclosed herein can be implemented in accordance with exemplary embodiments will be described+. The operating environment 100 includes a business 102. Although the concepts and technologies disclosed herein are applicable to any type of business, the concepts and technologies will be described as being directed to a telecommunications business such as a mobile network operator, landline network operator, or a combination thereof.

The illustrated operating environment 100 includes a technology ordering system 104, an application metadata system 106, and an integrated technology catalog (“ITC”) system 108. The business 102 also can include one or more business teams 109 (shown as business teams 109A-109N), each including one or more business team members 110. The business 102 also can include one or more compliance groups 111A-111N, each including one or more compliance group members (not shown). Each compliance group 111 is empowered by a stakeholder 112 (shown as stakeholders 112A-112N) to make a policy 113 on their behalf. Each compliance group 111 has a policy 113 and a compliance process 114, which the compliance group 111 advertises to the business 102 (e.g., email, training, etc.). The compliance groups 111 expect their respective policies 113 to be followed and their respective compliance processes 114. If not, the compliance process 114 may modify or halt business team 109 efforts. The policy 113 and the compliance process 114 of the compliance group 111 may refer to their own technology catalog, which is usually different from other compliance group's technology catalogs or what the business team 108 knows. Each business team 108 is supposed to know every policy 113 and compliance process 114. Each business team 108 should engage with the correct compliance process 114 if they interpret they are not compliance with the policy 113 requiring the compliance process 114. The policy 113 may reference technology, but the business teams 109 use their technology catalog versus the compliance groups' technology catalog, which may lead to a misinterpretation of the policy 113. If a business team 108 interprets that they are compliant with the policy 113 when they are not compliant, or are not aware of the policy 113, this may create plausible deniability and lead to forgiveness. In large corporations, there are many stakeholders 112, a given stakeholder 112 may have multiple compliance groups 111, each of which may have multiple policies 113 (e.g., hundreds), and a given policy 113 may refer to one or more compliance processes 114. For example, with a minimum of six compliance groups 111, each with multiple policies 113, and tens to thousands of business teams 108, one can understand how the complexity above increases exponentially.

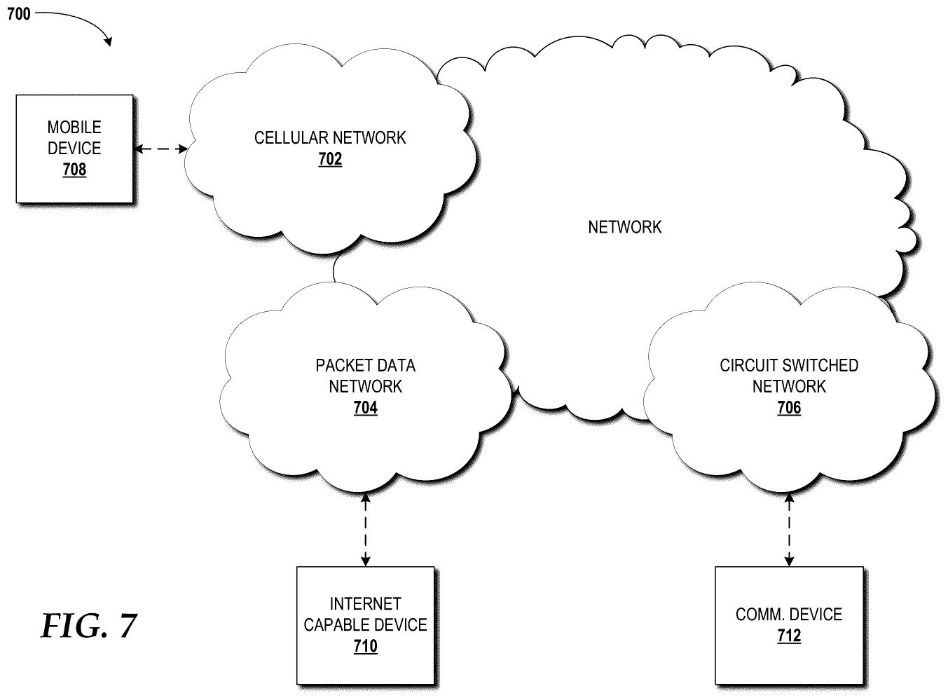

The business 102 and the aforementioned associated systems can operate in communication with one or more networks 115 such as the Internet and/or one or more intranets. The network(s) 115 can be implemented as one or more mobile networks and/or one or more landline networks. In some embodiments, the networks 115 can be implemented the same as or similar to a network 700 illustrated and described herein with reference to FIG. 7.

The technology ordering system 104 can provide a technology acquisition tool 114 through which the business team members 110 can order one or more technology products 116 (including hardware and/or software) provided by one or more technology vendors 118 based upon technology product reference data 120 provided by an externally-managed technology product catalog system 122. The technology ordering system 104 can communicate with the application metadata system 106 and the ITC system 108. In this manner, the opportunity for technology acquisition outside of the technology ordering system 104 can be reduced. Moreover, the technology ordering system 104 can leverage guidance provided by the ITC system 108 for approvals and requirements for implementing the technology product(s) 116. In some embodiments, the business team members 110 can interact with the technology ordering system 104 directly or via one or more business team systems 124. Although the technology ordering system 104 is shown at the business 102 premises, the technology ordering system 104 alternatively may be implemented as an external technology ordering system operating in communication with the network(s) 115. As such, the business team member(s) 110 can access the technology ordering system 104 remotely via the business team system(s) 124 connected to the network(s) 115. In some embodiments, the technology ordering system 104 is implemented as part of an existing technology ordering platform, such as SERVICENOW.

The application metadata system 106 can be a system of record for business application metadata, such as application-to-server mapping 126. In this illustrated example, the application metadata system 106 can contain the application-to-server mapping 126 for both a development environment 128 and a production environment 130.

The externally-managed technology product catalog system 122 can include technology product reference data 120. The technology product reference data 120 can include technology product records for a plurality of hardware and/or software products. Each of the technology product records can include a normalized representation of the technology product 116, the technology vendor 118, and available version(s) of the technology product 116. The technology product reference data 120 can include additional information such as retirement dates. In some embodiments, the externally-managed technology product catalog system 122 uses an existing managed technology catalog such as TECHNOPEDIA (available from FLEXERA). TECHNOPEDIA currently catalogs more than 4.9 million hardware and software products. Other managed technology catalogs are contemplated.

The ITC system 108 provides an ITC 132 that adds additional business-specific data fields on top of the technology product reference data 120. These additional data fields are shown as overlay data 133. The ITC 132 also includes one or more guidance rules 136 that are owned and managed by compliance groups (also referred to as compliance stakeholders) for technology. The guidance rules 136 are designed to evaluate the technology product(s) 116 in one or more contexts to identify whether or not the guidance rules 136 are applicable to the technology product(s) 116. The context can be new use of one or more of the technology products 116, an ongoing use of one or more of the technology products 116, one or more business functionalities, or a time. Each guidance rule 136 can include a reason as to why the guidance rule 136 exists. If applicable, a guidance rule 136 also can include a result, which can be prefer, avoid, or blocked (i.e., approval needed). For blocked technologies, a guidance rule 136 also can include a requirement, which is what is agreed to if the use of the technology is approved. Multiple guidance rules 136 evaluated against a technology product 116 can create a result set. Different guidance rules 136 may have different results because different compliance groups may have different opinions about a given technology product 116. All matching guidance rules 136 can be returned in a result set. An interpretation of the result set can be separate from the result set.

The business team member(s) 110 can use the business team system(s) 124 to access the ITC 132 via an interface 138 to view the technology product reference data 120, the overlay data 133, and the guidance rule(s) 136 applied. For example, the business team members 110 can submit requests 140 to evaluate one or more of the technology products 116 in a given context. The ITC system 108 can respond to the request(s) 140 with report(s) 142. The report(s) 142 can identify at least one of the guidance rules 136 applicable to the technology product(s) 116 identified in the request(s) 140. The report(s) 142 can include results/result sets.

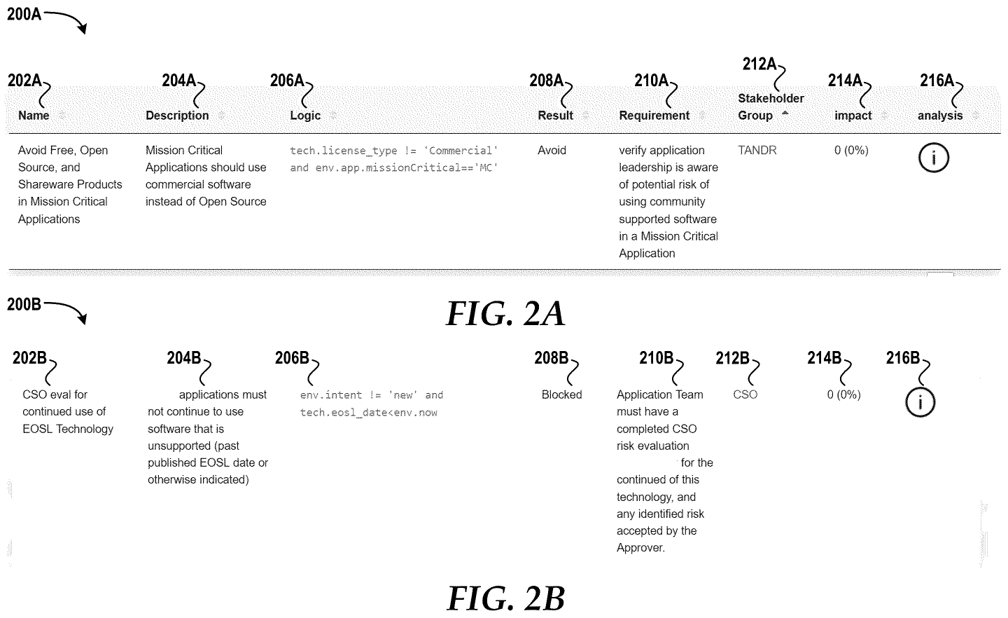

Turning now to FIGS. 2A-2B, interface diagrams 200A, 200B illustrating aspects of example guidance rules 136 will be described, according to an illustrative embodiment of the concepts and technologies disclosed herein. The interface diagrams 200A, 200B each include a name column 202A, 202B, a description column 204A, 204B, a logic column 206A, 206B, a result column 208A, 208B, a requirement column 210A, 210B, a stakeholder group column 212A, 212B, an impact column 214A, 214B, and an analysis column 216A, 216B.

The name columns 202A, 202B each include a name of a guidance rule. For example, the name column 202A includes the name, “Avoid Free, Open Source, and Shareware Products in Mission Critical Applications” of one guidance rule, and the name column 202B includes the name, “CSO eval for continued use of EOSL technology” for another guidance rule. The name can be more or less descriptive depending upon the preferences of the business 102.

The description columns 204A, 204B each include a description of a guidance rule 136. For example, the description column 204A includes the description, “Mission Critical Applications should use commercial software instead of Open Source” of one guidance rule 136, and the description column 204B includes the description, “applications must not continue to use software that is unsupported (past published end of service life date or otherwise indicated)” of another guidance rule 136. The description can include more or less detail depending upon the preferences of the business 102.

The logic columns 206A, 206B each include a logic snippet for a guidance rule 136. For example, the logic column 206A includes the logic snippet, “tech.license type !=‘Commercial’ and env.app.missionCritical==‘MC’” of one guidance rule 136, and the logic column 206B includes the logic snippet, “env.intent !=‘new’ and tech.eos1_date<env.now” of another guidance rule 136. The logic snippet in the logic column 206A uses the context “env.app” in reference to a specific business functionality, the features of which can be used as a consideration in a guidance rule 136. The logic snippet in the logic column 206B uses the context “env.now” in reference to a current date to compare against. In particular, the context “env.now” allows time-based comparisons, such as technology end of support dates compared to a current date. The context “env.now” can be moved forward or backwards to look at future/past guidance. The logic snippet in the logic column 206B also uses the context “env.intent” to specify whether the intent of the evaluation is for a new use/acquisition of a technology product 116 or an existing use. In the illustrated example, the context “env.intent” is used to specify that the intent is for a new use of a technology product 116.

The result columns 208A, 208B each include a result for a guidance rule 136. For example, the result column 208A includes an “Avoid” result, and the result column 208B includes a “Blocked” result. The result columns 208A, 208B alternatively can include a “Prefer” result. The result can be associated with a requirement, which is what is agreed to if the use of the technology product 116 is approved.

The requirement columns 210A, 210B each include a requirement for a guidance rule 136. For example, the requirement column 210A specifies a requirement to “verify application leadership is aware of potential risk of using community supported software in a Mission Critical Application” for a guidance rule 136, and the requirement column 210B specifies a requirement that the “Application Team must have a completed CSO risk evaluation for the continued use of this technology, and any identified risk accepted by the Approver” for another guidance rule 136.

The stakeholder group columns 212A, 212B each include an indication of the stakeholder group/team responsible for a guidance rule 136. For example, the stakeholder group column 212A includes an indication that “TANDR” is the stakeholder group responsible for a guidance rule 136, and the stakeholder group column 212B includes an indication that “CSO” is the stakeholder group responsible for another guidance rule 136.

The impact columns 214A, 214B include an indication of the impact (e.g., as a percentage) that non-compliance will have on the business 102. The analysis columns 216A, 216B include a detailed analysis of the guidance rule 136. In the illustrated example, an icon is shown that can be selected to view the detailed analysis.

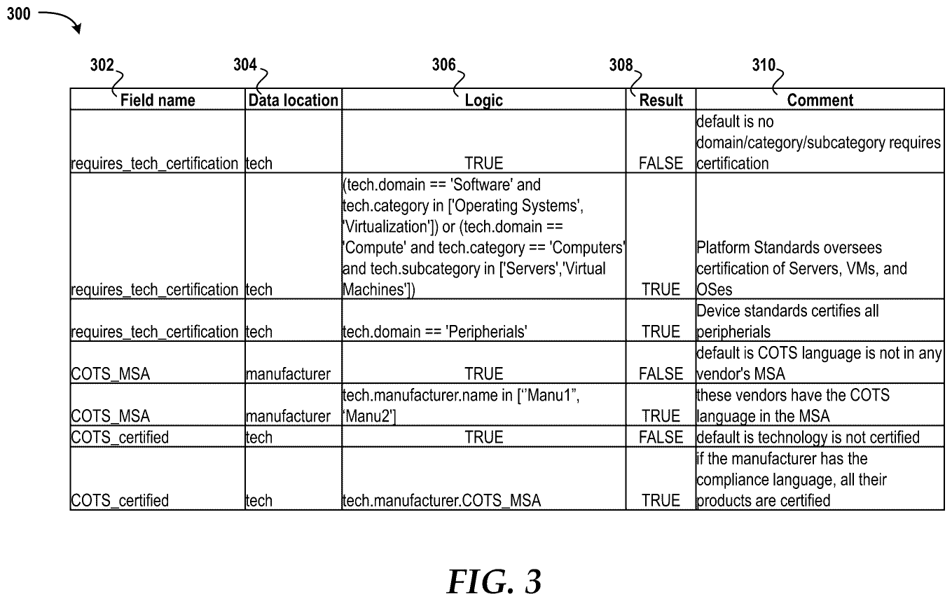

Turning now to FIG. 3, an overlay data diagram 300 illustrating aspects of example overlay data 133 will be described, according to an illustrative embodiment of the concepts and technologies disclosed herein. An external technology catalog, such as provided by the externally-managed technology product catalog system 122, can include hundreds or thousands of entries (shown as technology product reference data 120 in FIG. 1), however, business-sourced proprietary data (shown as overlay data 133 in FIG. 1) should be applied. The overlay data 133 is overlaid on top of the technology product reference data 120 using rule-based fields. Rule-based values are a way to express data as rules to set default values, to interpret existing data into a more intuitive form, to reference external data that may be variable, and for compression when there is limited variation. The overlay data 133 can be computed at runtime and is visible to the guidance rules 136.

The overlay data diagram 300 includes a field name column 302, a data location column 304, a logic column 306, a result column 308, and a comment column 310. The field name column 302 identifies a field name for a rules-based field in the overlay data 133. The data location column 304 identifies where the overlay data 133 associated with the rule-based field is located. The logic column 306 contains a logic snippet associated with the rule-based field. The result column 308 can include “TRUE” or “FALSE.” The comment column 310 includes a brief description of the overlay data 133.

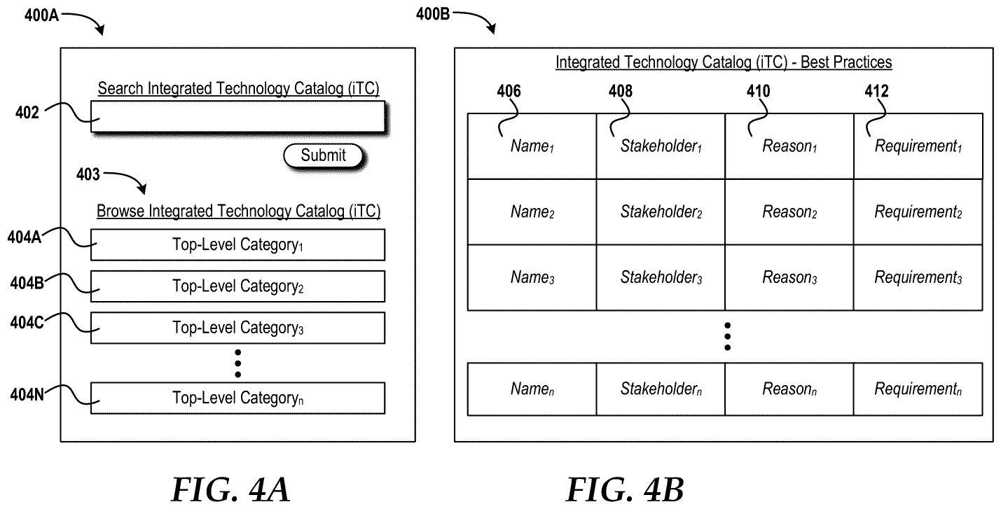

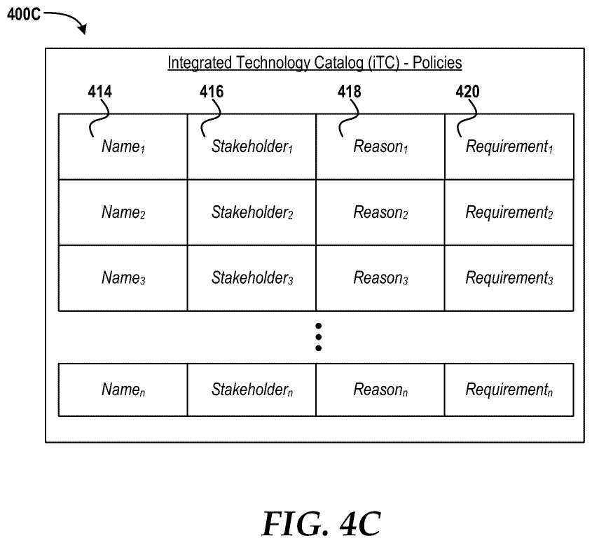

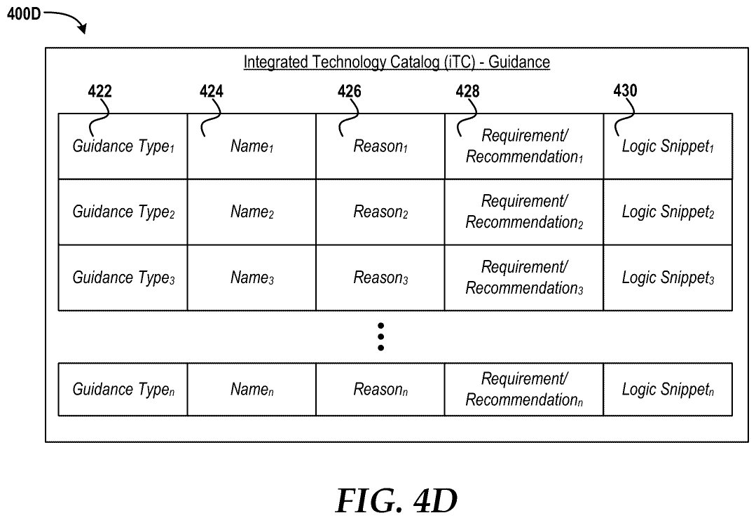

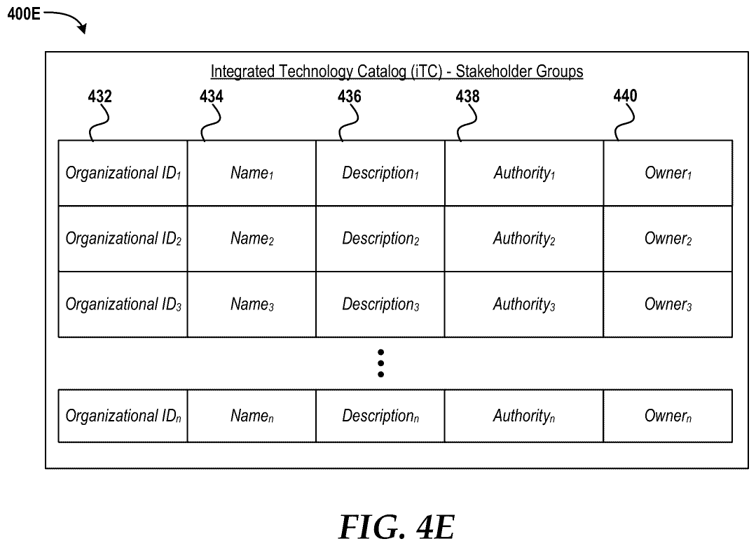

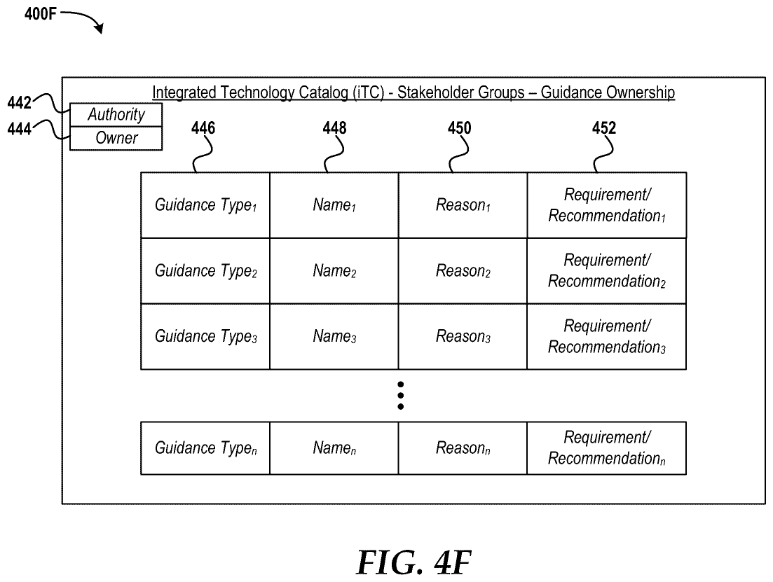

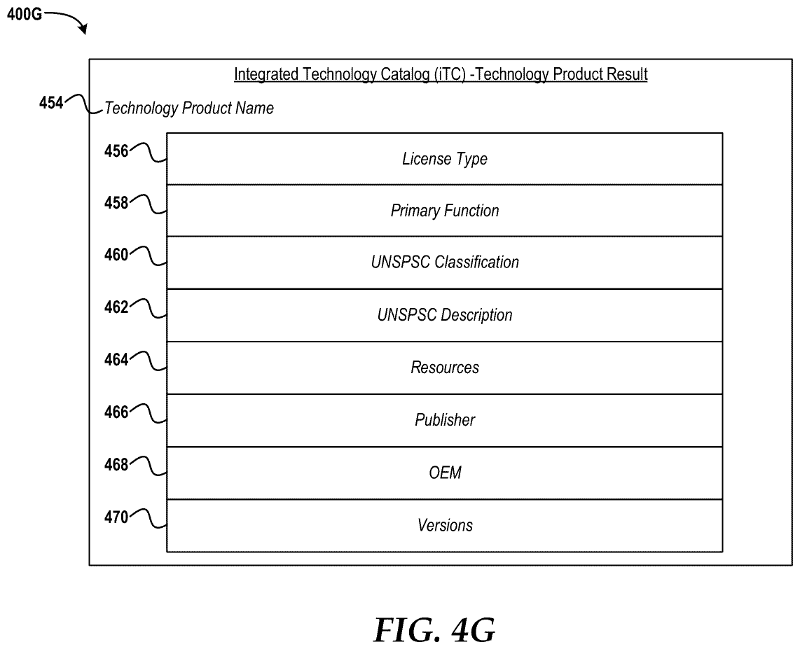

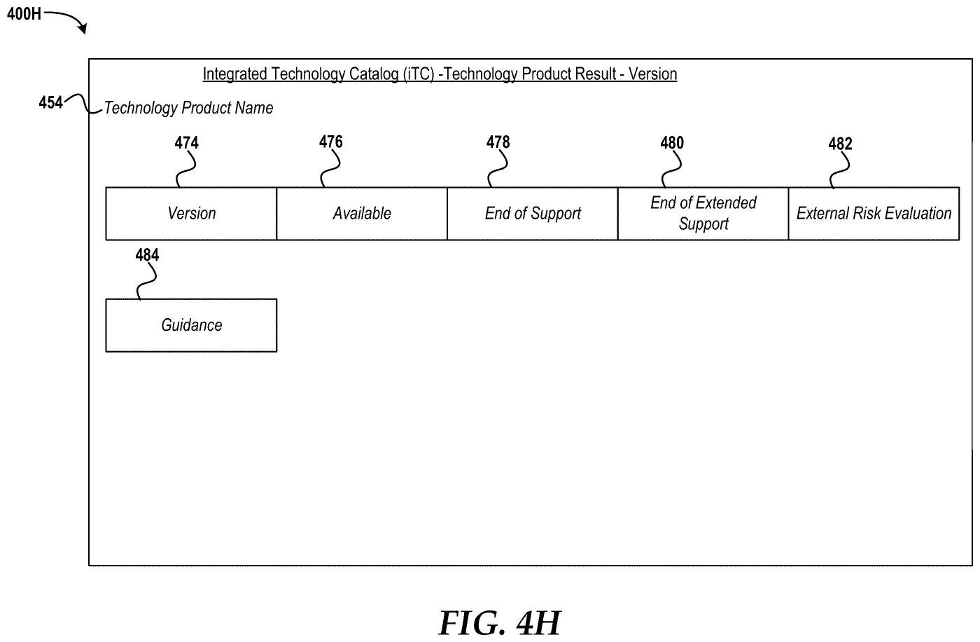

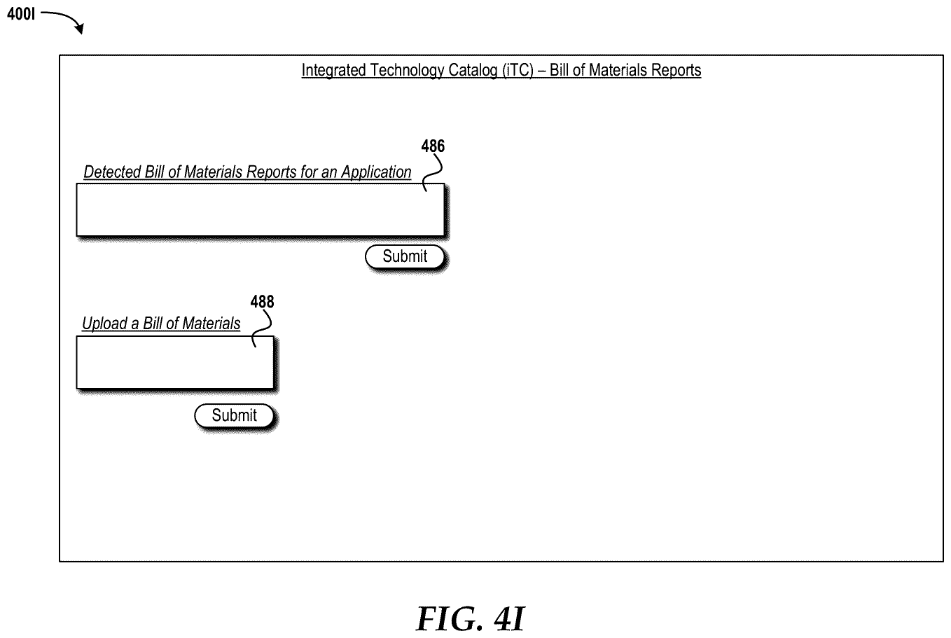

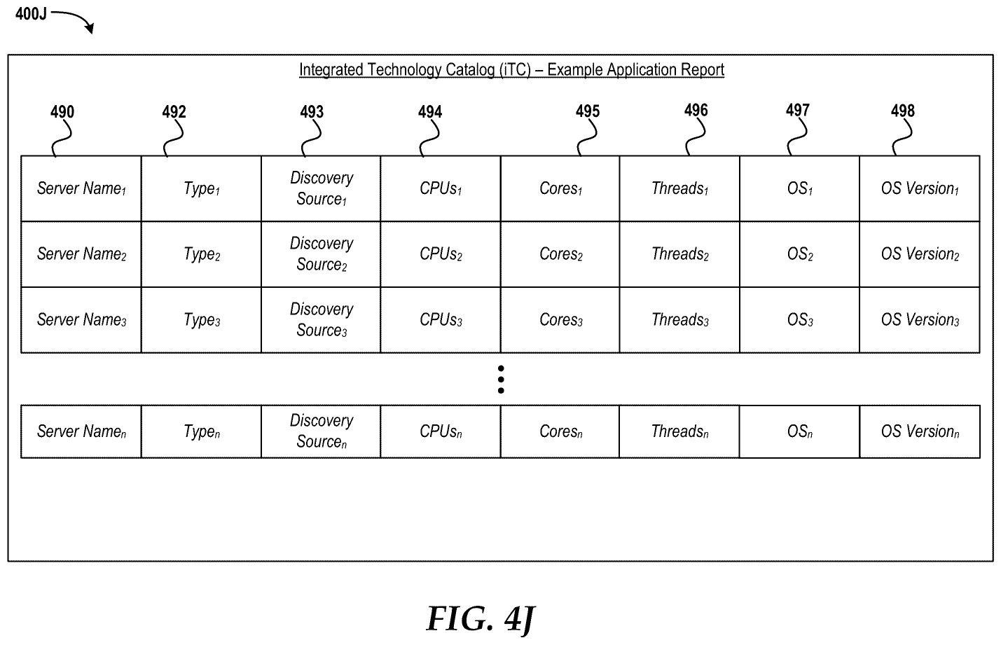

Turning now to FIGS. 4A-4J, UI diagrams 400A-400J illustrating aspects of an example ITC UI, such as implemented via the ITC system 108 as part of the interface 138, will be described, according to an illustrative embodiment of the concepts and technologies disclosed herein. The technology product reference data 120 contains products and categories. Presenting the technology product reference data 120 in its entirety might not be feasible. Instead, a UI, such as shown in the UI diagram 400A in FIG. 4A, can include a search UI element 402 and a browse UI element 403. The business team member(s) 110 can use the search UI element 402 to the technology product reference data 120 for manufacturers, product names, or categories by text. Alternatively, the business team members(s) 110 can use the browse UI element 404 to browse multiple top-level categories₁₋ₙ 404A-404N, each associated with a known technology category within the technology product reference data 120. In some embodiments, the browse UI element 404 also can include one or more lower-level categories (not shown) so that the business team member(s) 110 can drill down.

After a technology is selected, either via the search UI element 402 or the browse UI element 404, the UI diagram 400B can be presented to the business team member(s) 110. The UI diagram 400B shows, for the selected technology, any applicable best practices. In the illustrated example, the UI diagram 400B includes a name column 406, a stakeholder column 408, a reason column 410, and a requirement column 412. The name column 406 includes names of the best practices. The stakeholder column 408 identifies the stakeholders of the best practices. The reason column 410 provides a description of the reason why the best practices exist and what the best practices entail. The requirement column 412 specifies one or more requirements, if applicable, to implement the best practices.

After a technology is selected, either via the search UI element 402 or the browse UI element 404, the UI diagram 400C can be presented to the business team member(s) 110. The UI diagram 400C in FIG. 4C shows, for a selected technology, policies. In the illustrated example, the UI diagram 400C includes a name column 414, a stakeholder column 416, a reason column 418, and a requirement column 420. The name column 414 includes names of the policies. The stakeholder column 416 identifies the stakeholders of the policies. The reason column 418 provides a description of the reason why the policies exist and what the policies entail. The requirement column 420 specifies one or more requirements, if applicable, to implement the policies.

After a technology is selected, either via the search UI element 402 or the browse UI element 404, the UI diagram 400D can be presented to the business team member(s) 110. The UI diagram 400D in FIG. 4D shows, for a selected technology, guidance. In the illustrated example, the UI diagram 400D includes a guidance type column 422, a name column 424, a reason column 426, a requirement/recommendation column 428, and a logic snippet 430. The guidance type column 422 includes a guidance type indicating whether the guidance is a best practice, a policy, or another guidance type (e.g., strategic). The name column 424 includes names of the guidance. The reason column 426 provides a description of the reason why the guidance exists and what the guidance entails. The requirement/recommendation column 428 specifies one or more requirements and/or recommendations to implement the guidance. The logic snippet column 430 includes a logic snippet associated with the guidance.

An innovative feature of guidance is the ability to add a logic snippet so that when a technology is to be evaluated, the ITC system 108 can detect applicability of the guidance (e.g., best practice, policy, strategy, etc.) to the context. By way of example, and not limitation, for a vendor XYZ and product ABC, if the guidance applies to any product of XYZ, then “tech.manufacturer==‘XYZ’,” with the benefit that it will cover the product ABC (i.e., the product known as being provided by the vendor XYZ) and any other product provided by the vendor XYZ (e.g., a product that the enterprise may not know about or a product that may not currently exist), without enumerating each individual product. If the guidance is about the product ABC in particular, then “tech.manufacturer==‘XYZ’ && tech.name=‘ABC’,” and if the guidance is about a particular version of ABC (e.g., version ‘2010’ when the current version is ‘2022’), we can specify “tech.manufacturer==‘XYZ’ && tech.name=’ABC && tech.version==‘2010’.” The ITC system 108 also can consider orthogonal context such as whether the technology to be evaluated is for a new acquisition (“env.intent==‘new’”), ongoing use, or the current date.

After a technology is selected, either via the search UI element 402 or the browse UI element 404, the UI diagram 400E can be presented to the business team member(s) 110. The UI diagram 400E in FIG. 4E shows, for a selected technology, the stakeholder groups that are responsible for creating the guidance. In the illustrated example, the UI diagram 400E includes an organizational ID column 432, a name column 434, a description column 436, an authority column 438, and an owner column 440. The organizational ID column 432 includes identifiers associated with the stakeholder groups. An identifier can be a descriptive term (e.g., “AUTOMATION” for an automation stakeholder group) or an abbreviation (e.g., “DM” for a data management stakeholder group). The name column 434 includes names of the stakeholder groups. The description column 436 includes descriptions of the stakeholder groups. The authority column 438 identifies authorities that oversee the stakeholder groups (e.g., an individual or other stakeholder group). The owner column 440 identifies the owner of the stakeholder group.

After a technology is selected, either via the search UI element 402 or the browse UI element 404, the UI diagram 400F can be presented to the business team member(s) 110. The UI diagram 400F in FIG. 4F shows, for a selected technology, the guidance that each stakeholder owns. In the illustrated example, the UI diagram 400F identifies an authority 442 and an owner 444. The UI diagram 400F also includes a guidance type column 446, a name column 448, a reason column 450, and a requirement/recommendation column 452. The guidance type column 446 includes guidance types indicating whether the guidance is best practices, policies, or another guidance type (e.g., strategies). The name column 448 includes names of the guidance. The reason column 450 provides descriptions of the reasons why the guidance exists and what the guidance entails. The requirement/recommendation column 452 specifies one or more requirements and/or recommendations, if applicable, to implement the guidance.

After a technology is selected, either via the search UI element 402 or the browse UI element 404, the UI diagram 400G can be presented to the business team member(s) 110. The UI diagram 400G in FIG. 4G shows, for a selected technology, a technology product result, including a technology product name 454, a license type 456, a primary function 458, a United Nations Standard Products and Services Code® (“UNSPC”) classification 460, a UNSPSC description 462, any resources 464, a publisher 466, an OEM 468, and versions 470. The technology product name 454 identifies the technology product. The license type 456 identifies whether the license is a commercial license, a proprietary license, an open source license, or other license type. The primary function 458 identifies a primary function of the technology product. The UNSPC classification 460 identifies the UNSPC classification of the technology product. The UNSPC description 462 includes a description of the UNSPC classification. The resources 464 identify external resources that can be consulted for additional information about the technology product. The publisher 466 identifies the publisher of the technology product. The OEM 468 identifies the OEM of the technology product. The versions 470 identify what versions are available and whether or not the versions are compliant or non-compliant. All of the aforementioned data is externally sourced from the externally-managed technology product catalog system 122. The compliance status is sourced from the overlay data 133.

Upon selection of one of the versions 470, the UI diagram 400H can be presented to the business team member(s) 110. The UI diagram 400H includes the technology product name 454, the version 474, the availability date 476, the end of support date 478, the end of extended support 480, the external risk evaluation 482, and any applicable guidance 484. From here, the logic in the guidance rule 136 for “extended support” above can be found applicable because “env.now” is the current date between the end of support and end of extended support dates, the guidance rule 136 was a policy, and so the result status was “non-compliant” to that particular policy. In a “what-if” scenario to see what the status would be in the future and/or the past, “env.now” context can be adjusted to that date. For example, if “env.now” was changed to “1/1/2030” and this same evaluation is run, the extended support policy would not be applicable, but another similar “unsupported software” could be applicable. At an individual product level, this is useful, however, when applied to a group of technologies it become exponentially more powerful.

The UI diagram 400I in FIG. 41 shows, for a selected technology, a bill of materials report. The UI diagram 400I includes a detect bill of materials UI element 486 and an upload bill of materials UI element 488. To detect a bill of materials for an existing application, the business team member(s) 110 can input into the detect bill of materials UI element 486 an application name. The application server(s) that host the application can be inventoried by one or more discovery solutions for products. These products can be matched against the ITC 132, apply the guidance rule(s) 136, and generate a report 142 for the application. It should be noted that since the business team member(s) 110 can specify ongoing use or new use, the report 142 can be generated with “env.intent=‘existing’,” which may result in different guidance rules 136 being applicable (or not) versus “env.intent=‘new’.” Similarly, the business team member(s) 110 can upload an explicit bill of materials via the upload bill of materials UI element 488. The explicit bill of materials can include, for example, a future target architecture. In response, the report 142 can be generated identifying any stakeholder issues in deploying the target architecture before deployment. This can avoid avoidable issues or account for such issues if unavoidable.

The UI diagram 400J in FIG. 4J shows an example application report. The example application report includes a server name column 490, a type column 492, a discovery source column 493, a CPUs column 494, a cores column 495, a threads column 496, OS column 497, and an OS version 498. The server name column 490 includes the server names of the server upon which the application is installed. The type column 492 identifies the type of server. The discovery source column 493 identifies the discovery sources for the applications stored on the corresponding servers. The CPUs column 494 identifies the number of CPUs that each server has. The cores column 495 identifies the number of cores per CPU that each server has. The threads column 496 identifies the number of threads each core has. The OS column 497 and the OS version 498 identify, respectively, the OS and OS version installed on each server.

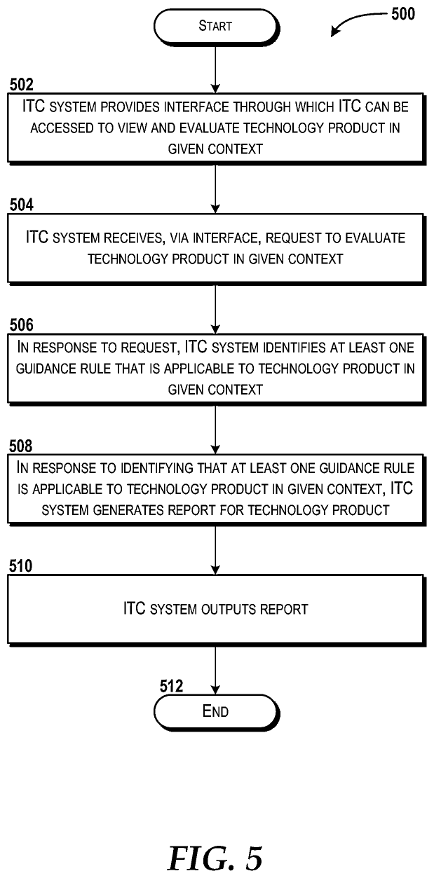

Turning now to FIG. 5, a method 500 for providing guidance rule-based compliance management will be described, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device to perform one or more operations, and/or causing the processor to direct other components of the computing system or device to perform one or more of the operations.

For purposes of illustrating and describing the concepts of the present disclosure, operations of the method disclosed herein are described as being performed by the ITC system 108. It should be understood that additional and/or alternative devices, servers, computers, and/or network nodes can provide the functionality described herein via execution of one or more modules, applications, and/or other software. Thus, the illustrated embodiments are illustrative, and should not be viewed as being limiting in any way.

The method 500 begins and proceeds to operation 502. At operation 502, the ITC system 108 provides the interface 138 through which the ITC 132 can be accessed to view and evaluate a technology product 116 in a given context. From operation 502, the method 500 proceeds to operation 504. At operation 504, the ITC system 108 receives, via the interface 138, the request 140 to evaluate the technology product 116 in the given context. From operation 504, the method 500 proceeds to operation 506. At operation 506, in response the request 140, the ITC system 108 identifies at least one guidance rule 136 that is applicable to the technology product 116 in the given context.

From operation 506, the method 500 proceeds to operation 508. At operation 508, in response to identifying that at least one guidance rule 136 is applicable to the technology product 116 in the given context, the ITC system 108 generates a report 142 for the technology product 116. From operation 508, the method 500 proceeds to operation 510. At operation 510, the ITC system 108 outputs the report 142.

From operation 510, the method 500 proceeds to operation 512. At operation 512, the method 500 can end.

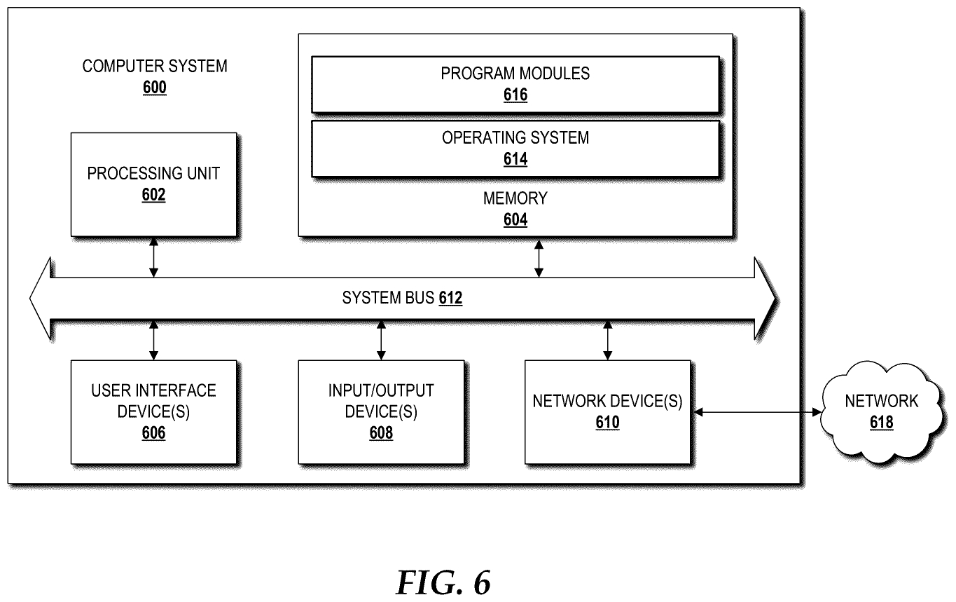

Turning now to FIG. 6, a block diagram illustrating a computer system 600 configured to provide the functionality described herein in accordance with various embodiments of the concepts and technologies disclosed herein. In some embodiments, the ITC system 108, the application metadata system 106, the technology ordering system 104, the externally-managed technology product catalog system 122, and/or other systems/devices disclosed herein can be configured like and/or can have an architecture similar or identical to the computer system 600 described herein with respect to FIG. 6. It should be understood, however, that any of these systems, devices, or elements may or may not include the functionality described herein with reference to FIG. 6.

The computer system 600 includes a processing unit 602, a memory 604, one or more user interface devices 606, one or more input/output (“I/O”) devices 608, and one or more network devices 610, each of which is operatively connected to a system bus 612. The bus 612 enables bi-directional communication between the processing unit 602, the memory 604, the user interface devices 606, the I/O devices 608, and the network devices 610.

The processing unit 602 may be a standard central processor that performs arithmetic and logical operations, a more specific purpose programmable logic controller (“PLC”), a programmable gate array, or other type of processor known to those skilled in the art and suitable for controlling the operation of the computer system 600.

The memory 604 communicates with the processing unit 602 via the system bus 612. In some embodiments, the memory 604 is operatively connected to a memory controller (not shown) that enables communication with the processing unit 602 via the system bus 612. The memory 604 includes an operating system 614 and one or more program modules 616. The operating system 614 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, and/or iOS families of operating systems from APPLE CORPORATION, the FREEBSD family of operating systems, the SOLARIS family of operating systems from ORACLE CORPORATION, other operating systems, and the like.

The program modules 616 may include various software and/or program modules described herein. By way of example, and not limitation, computer-readable media may include any available computer storage media or communication media that can be accessed by the computer system 600. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 600. In the claims, the phrase “computer storage medium,” “computer-readable storage medium,” and variations thereof does not include waves or signals per se and/or communication media, and therefore should be construed as being directed to “non-transitory” media only.

The user interface devices 606 may include one or more devices with which a user accesses the computer system 600. The user interface devices 606 may include, but are not limited to, computers, servers, personal digital assistants, cellular phones, or any suitable computing devices. The I/O devices 608 enable a user to interface with the program modules 616. In one embodiment, the I/O devices 608 are operatively connected to an I/O controller (not shown) that enables communication with the processing unit 602 via the system bus 612. The I/O devices 608 may include one or more input devices, such as, but not limited to, a keyboard, a mouse, or an electronic stylus. Further, the I/O devices 608 may include one or more output devices, such as, but not limited to, a display screen or a printer to output data.

The network devices 610 enable the computer system 600 to communicate with other networks or remote systems via one or more networks 618, such as the network(s) 115. Examples of the network devices 610 include, but are not limited to, a modem, a RF or infrared (“IR”) transceiver, a telephonic interface, a bridge, a router, or a network card. The network(s) may include a wireless network such as, but not limited to, a wireless local area network (“WLAN”) such as a WI-FI network, a wireless wide area network (“WWAN”), a Wireless Personal Area Network (“WPAN”) such as BLUETOOTH, a wireless metropolitan area network (“WMAN”) such a WiMAX network, or a cellular network. Alternatively, the network(s) may be a wired network such as, but not limited to, a WAN such as the Internet, a LAN, a wired PAN, or a wired MAN.

Turning now to FIG. 7, a network 700 is illustrated, according to an illustrative embodiment. In some embodiments, the network(s) 115 can be configured the same as or similar to the network 700. The illustrated network 700 includes a cellular network 702 (e.g., mobile network), a packet data network 704, for example, the Internet, and a circuit switched network 706, for example, a publicly switched telephone network (“PSTN”). The cellular network 702 includes various components such as, but not limited to, base transceiver stations (“BTSs”), Node-B's, e-Node-B's, g-Node-B's base station controllers (“BSCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, an IP Multimedia Subsystem (“IMS”), and the like. The cellular network 702 also includes radios and nodes for receiving and transmitting voice, data, and combinations thereof to and from radio transceivers, networks, the packet data network 704, and the circuit switched network 706.

A mobile communications device 708, such as, for example, a cellular telephone, a user equipment, a mobile terminal, a PDA, a laptop computer, a handheld computer, and combinations thereof, can be operatively connected to the cellular network 702. The mobile communications device 708 can be operatively connected to the cellular network 702. The cellular network 702 can be configured as a 2G GSM network and can provide data communications via GPRS and/or EDGE. Additionally, or alternatively, the cellular network 702 can be configured as a 3G UMTS network and can provide data communications via the HSPA protocol family, for example, HSDPA, EUL (also referred to as HSUPA), and HSPA+. The cellular network 702 also is compatible with 4G mobile communications standards as well as evolved and future mobile standards.

The packet data network 704 includes various devices, for example, the technology ordering system 104, the application metadata system 106, the ITC system 108, the business team system(s) 124, and other devices in communication with another, as is generally known. The packet data network 704 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 704 includes or is in communication with the Internet.

The circuit switched network 706 includes various hardware and software for providing circuit switched communications. The circuit switched network 706 may include, or may be, what is often referred to as a plain old telephone system (“POTS”). The functionality of a circuit switched network 706 or other circuit-switched network are generally known and will not be described herein in detail.

The illustrated cellular network 702 is shown in communication with the packet data network 704 and a circuit switched network 706, though it should be appreciated that this is not necessarily the case. One or more Internet-capable devices 710, for example, the technology ordering system 104, the application metadata system 106, the ITC system 108, the business team system(s) 124, a personal computer (“PC”), a laptop, a portable device, or another suitable device, can communicate with one or more cellular networks 702, and devices connected thereto, through the packet data network 704. It also should be appreciated that the Internet-capable device 710 can communicate with the packet data network 704 through the circuit switched network 706, the cellular network 702, and/or via other networks (not illustrated).

As illustrated, a communications device 712, for example, a telephone, facsimile machine, modem, computer, or the like, can be in communication with the circuit switched network 706, and therethrough to the packet data network 704 and/or the cellular network 702. It should be appreciated that the communications device 712 can be an Internet-capable device, and can be substantially similar to the Internet-capable device 710.

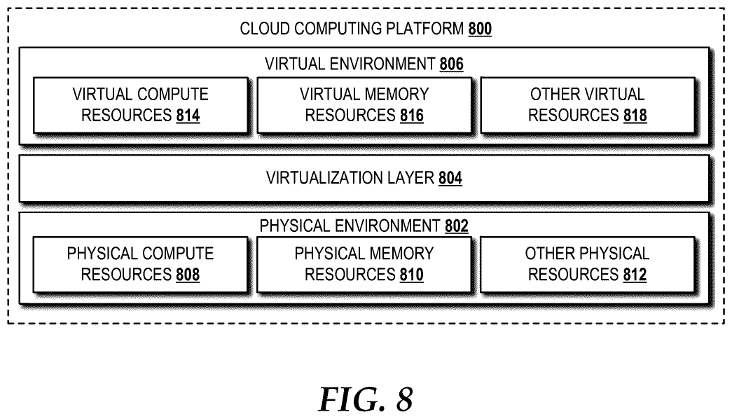

Turning now to FIG. 8, an illustrative cloud computing platform 800 will be described, according to an illustrative embodiment. In some embodiments, the ITC system 108, the application metadata system 106, the technology ordering system 104, the externally-managed technology product catalog system 122, the production environment 130, the development environment 128, and/or other systems/devices disclosed herein can be configured like and/or can have an architecture similar or identical to the and/or other networks, systems, and/or devices disclosed herein can be implemented and/or controlled, at least in part, in/by the cloud computing platform 800.

The cloud computing platform 800 includes a physical environment 802, a virtualization layer 804, and a virtual environment 806. While no connections are shown in FIG. 8, it should be understood that some, none, or all of the components illustrated in FIG. 8 can be configured to interact with one other to carry out various functions described herein. In some embodiments, the components are arranged so as to communicate via one or more networks. Thus, it should be understood that FIG. 8 and the remaining description are intended to provide a general understanding of a suitable environment in which various aspects of the embodiments described herein can be implemented, and should not be construed as being limiting in any way.

The physical environment 802 provides hardware resources that, in the illustrated embodiment, include one or more physical compute resources 808, one or more physical memory resources 810, and one or more other physical resources 812.

The physical compute resource(s) 808 can include one or more hardware components that perform computations to process data and/or to execute computer-executable instructions of one or more application programs, one or more operating systems, and/or other software. The physical compute resources 808 can include one or more central processing units (“CPUs”) configured with one or more processing cores. The physical compute resources 808 can include one or more graphics processing unit (“GPU”) configured to accelerate operations performed by one or more CPUs, and/or to perform computations to process data, and/or to execute computer-executable instructions of one or more application programs, one or more operating systems, and/or other software that may or may not include instructions particular to graphics computations. In some embodiments, the physical compute resources 808 can include one or more discrete GPUs. In some other embodiments, the physical compute resources 808 can include CPU and GPU components that are configured in accordance with a co-processing CPU/GPU computing model, wherein the sequential part of an application executes on the CPU and the computationally-intensive part is accelerated by the GPU processing capabilities. The physical compute resources 808 can include one or more system-on-chip (“SoC”) components along with one or more other components, including, for example, one or more of the physical memory resources 810, and/or one or more of the other physical resources 812. In some embodiments, the physical compute resources 808 can be or can include one or more SNAPDRAGON SoCs, available from QUALCOMM of San Diego, California; one or more TEGRA SoCs, available from NVIDIA of Santa Clara, California; one or more HUMMINGBIRD SoCs, available from SAMSUNG of Seoul, South Korea; one or more Open Multimedia Application Platform (“OMAP”) SoCs, available from TEXAS INSTRUMENTS of Dallas, Texas; one or more customized versions of any of the above SoCs; and/or one or more proprietary SoCs. The physical compute resources 808 can be or can include one or more hardware components architected in accordance with an ARM architecture, available for license from ARM HOLDINGS of Cambridge, United Kingdom. Alternatively, the physical compute resources 808 can be or can include one or more hardware components architected in accordance with an x86 architecture, such an architecture available from INTEL CORPORATION of Mountain View, California, and others. Those skilled in the art will appreciate the implementation of the physical compute resources 808 can utilize various computation architectures, and as such, the physical compute resources 808 should not be construed as being limited to any particular computation architecture or combination of computation architectures, including those explicitly disclosed herein.

The physical memory resource(s) 810 can include one or more hardware components that perform storage/memory operations, including temporary or permanent storage operations. In some embodiments, the physical memory resource(s) 810 include volatile and/or non-volatile memory implemented in any method or technology for storage of information such as computer-readable instructions, data structures, program modules, or other data disclosed herein. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store data and which can be accessed by the physical compute resources 808.

The other physical resource(s) 812 can include any other hardware resources that can be utilized by the physical compute resources(s) 808 and/or the physical memory resource(s) 810 to perform operations described herein. The other physical resource(s) 812 can include one or more input and/or output processors (e.g., network interface controller or wireless radio), one or more modems, one or more codec chipset, one or more pipeline processors, one or more fast Fourier transform (“FFT”) processors, one or more digital signal processors (“DSPs”), one or more speech synthesizers, and/or the like.

The physical resources operating within the physical environment 802 can be virtualized by one or more virtual machine monitors (not shown; also known as “hypervisors”) operating within the virtualization/control layer 804 to create virtual resources that reside in the virtual environment 806. The virtual machine monitors can be or can include software, firmware, and/or hardware that alone or in combination with other software, firmware, and/or hardware, creates and manages virtual resources operating within the virtual environment 806.

The virtual resources operating within the virtual environment 806 can include abstractions of at least a portion of the physical compute resources 808, the physical memory resources 810, and/or the other physical resources 812, or any combination thereof, shown as virtual compute resources 814, virtual memory resources 816, and other virtual resources 818, respectively. In some embodiments, the abstractions can include one or more virtual machines upon which one or more applications can be executed.

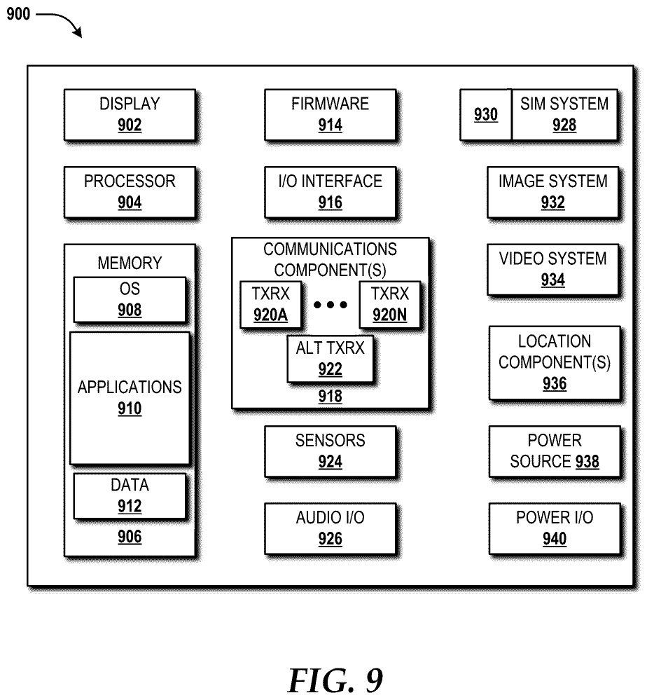

Turning now to FIG. 9, an illustrative mobile device 900 and components thereof will be described. In some embodiments, one or more of the business team system(s) 124 described above can be configured as and/or can have an architecture similar or identical to the mobile device 900 described herein in FIG. 9. While connections are not shown between the various components illustrated in FIG. 9, it should be understood that some, none, or all of the components illustrated in FIG. 9 can be configured to interact with one another to carry out various device functions. In some embodiments, the components are arranged so as to communicate via one or more busses (not shown). Thus, it should be understood that FIG. 9 and the following description are intended to provide a general understanding of a suitable environment in which various aspects of embodiments can be implemented, and should not be construed as being limiting in any way.

As illustrated in FIG. 9, the mobile device 900 can include a display 902 for displaying data. According to various embodiments, the display 902 can be configured to display data described herein, network connection information, various GUI elements, text, images, video, virtual keypads and/or keyboards, messaging data, notification messages, metadata, Internet content, device status, time, date, calendar data, device preferences, map and location data, combinations thereof, and/or the like. The mobile device 900 also can include a processor 904 and a memory or other data storage device (“memory”) 906. The processor 904 can be configured to process data and/or can execute computer-executable instructions stored in the memory 906. The computer-executable instructions executed by the processor 904 can include, for example, an operating system 908, one or more applications 910, other computer-executable instructions stored in the memory 906, or the like. In some embodiments, the applications 910 also can include a UI application (not illustrated in FIG. 9).

The UI application can interface with the operating system 908 to facilitate user interaction with functionality and/or data stored at the mobile device 900 and/or stored elsewhere. In some embodiments, the operating system 908 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 904 to aid a user in data communications, entering/deleting data, entering and setting user IDs and passwords for device access, configuring settings, manipulating content and/or settings, multimode interaction, interacting with other applications 910, and otherwise facilitating user interaction with the operating system 908, the applications 910, and/or other types or instances of data 912 that can be stored at the mobile device 900.

The applications 910, the data 912, and/or portions thereof can be stored in the memory 906 and/or in a firmware 914, and can be executed by the processor 904. The firmware 914 also can store code for execution during device power up and power down operations. It can be appreciated that the firmware 914 can be stored in a volatile or non-volatile data storage device including, but not limited to, the memory 906 and/or a portion thereof.

The mobile device 900 also can include an input/output (“I/O”) interface 916. The I/O interface 916 can be configured to support the input/output of data such as location information, presence status information, user IDs, passwords, and application initiation (start-up) requests. In some embodiments, the I/O interface 916 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45) port, an RJ11 port, a proprietary port, combinations thereof, or the like. In some embodiments, the mobile device 900 can be configured to synchronize with another device to transfer content to and/or from the mobile device 900. In some embodiments, the mobile device 900 can be configured to receive updates to one or more of the applications 910 via the I/O interface 916, though this is not necessarily the case. In some embodiments, the I/O interface 916 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 916 may be used for communications between the mobile device 900 and a network device or local device.

The mobile device 900 also can include a communications component 918. The communications component 918 can be configured to interface with the processor 904 to facilitate wired and/or wireless communications with one or more networks. In some embodiments, the communications component 918 includes a multimode communications subsystem for facilitating communications via the cellular network and one or more other networks.

The communications component 918, in some embodiments, includes one or more transceivers. The one or more transceivers, if included, can be configured to communicate over the same and/or different wireless technology standards with respect to one another. For example, in some embodiments, one or more of the transceivers of the communications component 918 may be configured to communicate using GSM, CDMAONE, CDMA2000, LTE, and various other 2G, 2.5G, 3G, 4G, 4.5G, 5G, and greater generation technology standards. Moreover, the communications component 918 may facilitate communications over various channel access methods (which may or may not be used by the aforementioned standards) including, but not limited to, TDMA, FDMA, W-CDMA, OFDM, SDMA, and the like.

In addition, the communications component 918 may facilitate data communications using GPRS, EDGE, the HSPA protocol family including HSDPA, EUL or otherwise termed HSUPA, HSPA+, and various other current and future wireless data access standards. In the illustrated embodiment, the communications component 918 can include a first transceiver (“TxRx”) 920A that can operate in a first communications mode (e.g., GSM). The communications component 918 also can include an Nth transceiver (“TxRx”) 920N that can operate in a second communications mode relative to the first transceiver 920A (e.g., UMTS). While two transceivers 920A-920N (hereinafter collectively and/or generically referred to as “transceivers 920”) are shown in FIG. 9, it should be appreciated that less than two, two, and/or more than two transceivers 920 can be included in the communications component 918.

The communications component 918 also can include an alternative transceiver (“Alt TxRx”) 922 for supporting other types and/or standards of communications. According to various contemplated embodiments, the alternative transceiver 922 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 918 also can facilitate reception from terrestrial radio networks, digital satellite radio networks, internet-based radio service networks, combinations thereof, and the like. The communications component 918 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 900 also can include one or more sensors 924. The sensors 924 can include temperature sensors, light sensors, air quality sensors, movement sensors, accelerometers, magnetometers, gyroscopes, infrared sensors, orientation sensors, noise sensors, microphones proximity sensors, combinations thereof, and/or the like. Additionally, audio capabilities for the mobile device 900 may be provided by an audio I/O component 926. The audio I/O component 926 of the mobile device 900 can include one or more speakers for the output of audio signals, one or more microphones for the collection and/or input of audio signals, and/or other audio input and/or output devices.

The illustrated mobile device 900 also can include a subscriber identity module (“SIM”) system 928. The SIM system 928 can include a universal SIM (“USIM”), a universal integrated circuit card (“UICC”) and/or other identity devices. The SIM system 928 can include and/or can be connected to or inserted into an interface such as a slot interface 930. In some embodiments, the slot interface 930 can be configured to accept insertion of other identity cards or modules for accessing various types of networks. Additionally, or alternatively, the slot interface 930 can be configured to accept multiple subscriber identity cards. Because other devices and/or modules for identifying users and/or the mobile device 900 are contemplated, it should be understood that these embodiments are illustrative, and should not be construed as being limiting in any way.

The mobile device 900 also can include an image capture and processing system 932 (“image system”). The image system 932 can be configured to capture or otherwise obtain photos, videos, and/or other visual information. As such, the image system 932 can include cameras, lenses, charge-coupled devices (“CCDs”), combinations thereof, or the like. The mobile device 900 may also include a video system 934. The video system 934 can be configured to capture, process, record, modify, and/or store video content. Photos and videos obtained using the image system 932 and the video system 934, respectively, may be added as message content to an MMS message, email message, and sent to another device. The video and/or photo content also can be shared with other devices via various types of data transfers via wired and/or wireless communication devices as described herein.

The mobile device 900 also can include one or more location components 936. The location components 936 can be configured to send and/or receive signals to determine a geographic location of the mobile device 900. According to various embodiments, the location components 936 can send and/or receive signals from global positioning system (“GPS”) devices, assisted-GPS (“A-GPS”) devices, WI-FI/WIMAX and/or cellular network triangulation data, combinations thereof, and the like. The location component 936 also can be configured to communicate with the communications component 918 to retrieve triangulation data for determining a location of the mobile device 900. In some embodiments, the location component 936 can interface with cellular network nodes, telephone lines, satellites, location transmitters and/or beacons, wireless network transmitters and receivers, combinations thereof, and the like. In some embodiments, the location component 936 can include and/or can communicate with one or more of the sensors 924 such as a compass, an accelerometer, and/or a gyroscope to determine the orientation of the mobile device 900. Using the location component 936, the mobile device 900 can generate and/or receive data to identify its geographic location, or to transmit data used by other devices to determine the location of the mobile device 900. The location component 936 may include multiple components for determining the location and/or orientation of the mobile device 900.

The illustrated mobile device 900 also can include a power source 938. The power source 938 can include one or more batteries, power supplies, power cells, and/or other power subsystems including alternating current (“AC”) and/or direct current (“DC”) power devices. The power source 938 also can interface with an external power system or charging equipment via a power I/O component 940. Because the mobile device 900 can include additional and/or alternative components, the above embodiment should be understood as being illustrative of one possible operating environment for various embodiments of the concepts and technologies described herein. The described embodiment of the mobile device 900 is illustrative, and should not be construed as being limiting in any way.

As used herein, communication media includes computer-executable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared, and other wireless media. Combinations of the any of the above should also be included within the scope of computer-readable media.

By way of example, and not limitation, computer storage media may include volatile and non-volatile, removable and non-removable media implemented in any method or technology for storage of information such as computer-executable instructions, data structures, program modules, or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the mobile device 900 or other devices or computers described herein, such as the computer system 600 described above with reference to FIG. 6. For purposes of the claims, the phrase “computer-readable storage medium” and variations thereof, does not include waves, signals, and/or other transitory and/or intangible communication media, per se.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations may take place in the mobile device 900 in order to store and execute the software components presented herein. It is also contemplated that the mobile device 900 may not include all of the components shown in FIG. 9, may include other components that are not explicitly shown in FIG. 9, or may utilize an architecture completely different than that shown in FIG. 9.

Based on the foregoing, it should be appreciated that aspects of guidance-based compliance management have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A method comprising:
providing, by an integrated technology catalog system, an interface through which a technology catalog can be accessed to view a technology product and evaluate the technology product in a given context;
receiving, by the integrated technology catalog system, via the interface, a request to evaluate the technology product in the given context;
in response to the request, identifying, by the integrated technology catalog system, whether at least one guidance rule is applicable to the technology product in the given context;
in response to identifying that the at least one guidance rule is applicable to the technology product in the given context, generating, by the integrated technology catalog system, a report for the technology product, wherein the report comprises all applicable guidance rules for the technology product; and
outputting, by the integrated technology catalog system, the report.

2. The method of claim 1, wherein the technology catalog comprises a plurality of technology products comprising the technology product, and wherein the technology catalog comprises a set of core attributes that uniquely identify the technology product.

3. The method of claim 2, wherein the technology catalog further comprises a set of additional attributes of the technology product.

4. The method of claim 3, wherein the interface comprises a search function.

5. The method of claim 1, wherein the at least one guidance rule comprises information to be provided to a user or used to trigger an activity, and wherein the information represents a best practice, a policy, or a strategy.

6. The method of claim 5, wherein the at least one guidance rule comprises a logic snippet; and wherein identifying, by the integrated technology catalog system, whether the at least one guidance rule is applicable to the technology product in the given context comprises identifying, by the integrated technology catalog system, via execution of the logic snippet, whether the at least one guidance rule is applicable to the technology product in the given context.

7. The method of claim 6, wherein the at least one guidance rule is defined and managed by a stakeholder group.

8. The method of claim 1, wherein the context comprises a new use of the technology product or an ongoing use of the technology product.

9. The method of claim 1, wherein the given context comprises a time.

10. The method of claim 1, wherein the given context comprises a business functionality.

11. The method of claim 1, wherein the request specifies a bill of materials.

12. An integrated technology catalog system comprising:
a processor; and
a memory comprising instructions that, when executed by the processor, cause the processor to perform operations comprising
providing an interface through which a technology catalog can be accessed to view a technology product and evaluate the technology product in a given context,
receiving, via the interface, a request to evaluate the technology product in the given context,
in response to the request, identifying whether at least one guidance rule is applicable to the technology product in the given context,
in response to identifying that the at least one guidance rule is applicable to the technology product in the given context, generating a report for the technology product, wherein the report comprises all applicable guidance rules for the technology product, and
outputting the report.

13. The integrated technology catalog system of claim 12, wherein the technology catalog comprises a plurality of technology products comprising the technology product, and wherein the technology catalog comprises a set of core attributes that uniquely identify the technology product.

14. The integrated technology catalog system of claim 13, wherein the technology catalog further comprises a set of additional attributes of the technology product.

15. The integrated technology catalog system of claim 14, wherein the interface comprises a search function.

16. The integrated technology catalog system of claim 12, wherein the at least one guidance rule comprises information to be provided to a user or used to trigger an activity, and wherein the information represents a best practice, a policy, or a strategy.

17. The integrated technology catalog system of claim 16, wherein the at least one guidance rule comprises a logic snippet; wherein identifying whether the at least one guidance rule is applicable to the technology product in the given context comprises identifying, via execution of the logic snippet, whether the at least one guidance rule is applicable to the technology product in the given context; and wherein the given context comprises an ongoing use of the technology product, a new use of the technology product, a time, or a business functionality.

18. A computer storage medium comprising computer-executable instructions that, when executed by a processor, cause the processor to perform operations comprising:
providing an interface through which a technology catalog can be accessed to view a technology product and evaluate the technology product in a given context;
receiving, via the interface, a request to evaluate the technology product in the given context;
in response to the request, identifying whether at least one guidance rule is applicable to the technology product in the given context;
in response to identifying that the at least one guidance rule is applicable to the technology product in the given context, generating a report for the technology product, wherein the report comprises all applicable guidance rules for the technology product; and
outputting the report.

19. The computer storage medium of claim 18, wherein the technology catalog comprises a plurality of technology products comprising the technology product, and wherein the technology catalog comprises a set of core attributes that uniquely identify the technology product.

20. The computer storage medium of claim 19, wherein the technology catalog further comprises a set of additional attributes of the technology product.
